(19) United States
(12) Patent Application Publication
(10) Pub. No.: US 2004/0141723 A1
(43) Pub. Date: Jul. 22, 2004

(54) Editing apparatus

(76) Inventor: Keiichi Sakano, Osaka (JP)

Correspondence Address: RATNERPRESTIA, P O BOX 980, VALLEY FORGE, PA, 19482-0980, US

(21) Appl. No.: 10/706,023

(22) Filed: Nov. 12, 2003

(30) Foreign Application Priority Data
Nov. 19, 2002 (JP) 2002-334830

(51) Int. Cl. H04N 5/76; G11B 27/00

(52) U.S. Cl. 386/52; 386/55

(57) ABSTRACT

Presented herein is an editing apparatus capable of restoring a material from either media of original media and backup media, and backing up or restoring by using different media. This editing apparatus comprises a material storage for storing a material, a material capture unit for taking in a material from external media to the material storage, a material output unit for sending the material stored in the material storage to external media, and a material information management unit for managing external media information for specifying at least either one of the external media and material storing place in the external media, in which the material information management unit has an external media information store region.

### FIELD OF THE INVENTION

The present invention relates to an editing apparatus of such as video and audio, and more particularly to backup and restoring of material in an editing apparatus.

### BACKGROUND OF THE INVENTION

In an editing apparatus, a material such as video data and management information relating to this material are mutually related and recorded as a file on a random access medium such as hard disk. The random access medium also has an index region for managing the recorded file, and by referring to this index region, the recorded material and material management information can be acquired instantly. Such conventional editing apparatus is disclosed, for example, in Japanese Laid-open Patent No. H9-161464. Such editing apparatus is often called as nonlinear editing apparatus.

The backup and restoring method in the conventional editing apparatus is explained. Referring to FIG. 6, capture of material is explained. In FIG. 6, the material on the tape such as video reproduced by a VTR (not shown in FIG. 6) is captured in by a material capture unit 1010, and is sent to a recording and reproducing control unit 1030. The recording and reproducing control unit 1030 stores the material into a material storage 1040 such as hard disk, and sends material area information showing the stored position (sector) of the material on the hard disk to a material information management unit 1050. The material information management unit 1050 stores this material area information in a material area information store region 1070. Simultaneously with capture of the material, the material capture unit 1010 acquires the reel number information and material time code information from the tape (hereinafter called original tape), and sends them to the material information management unit 1050. The material information management unit 1050 stores these pieces of information in an external media information store region 1060.

Next, in FIG. 7, the material backup procedure is explained. In FIG. 7, when the user requests backup of a certain material (not shown in FIG. 7), the recording and reproducing control unit 1030 receives the material area information of the material from the material information management unit 1050. On the basis of the received material area information, the recording and reproducing control unit 1030 reads out the material in the material storage 1040, and records (backs up) into the tape loaded in the VTR from a material output unit 1020. At this time, a new reel number and time code are written into the backup tape. The new reel number and time code are determined, for example, by specifying by the user. The material information management unit 1050 rewrites the data in the external media information store region 1060 to the new reel number and new time code information. FIG. 8 shows an example of material area information and external media information at this time.

In FIG. 8, a material identifier 1041 shows the material stored in the material storage 1040, in which “Material 1” to “Material4” are present. Material area information 1071 shows the information stored in the material area information store region 1070. The material area information 1071 stores sector values of the material storage 1040 corresponding to “Material 1” to “Material 4”. External media information 1061 shows the information stored in the external media information store region 1060. The external media information 1061 stores reel number 1062 and time code 1063 of external media corresponding to “Material 1” to “Material 4”.

In this way, the material area information and external media information are stored in each material being captured in.

The material in the material storage 1040 may be temporarily deleted from the material storage 1040 for the purpose of increasing the vacant capacity of the material storage 1040 or other reason. When this material is needed later, the material is captured-again from the tape and restored.

This restoring procedure is explained. When the user requests to restore a certain material (not shown in FIG. 6), the material information management unit 1050 reads out the reel number 1062 and time code 1063 of the material specified by the user from the external media information store region 1060. The material information management unit 1050 sends the information to the recording and reproducing control unit 1030. The recording and reproducing control unit 1030 sends the information to the material capture unit 1010. The material capture unit 1010, on the basis of the reel number 1062 and time code 1063, first checks if the reel number 1062 coincides with the reel number of the tape loaded in the VTR or not, and seeks the tape (rewinds or forwards) up to the position specified by the time code 1063, and caputures in. The captured material is sent to the recording and reproducing control unit 1030, and the recording and reproducing control unit 1030 stores this material in the material storage 1040.

The material held by the material information management unit 1050 in the external media information store region 1060 comprises the reel number 1062 and time code 1063 of the backup tape, and when the backup tape is loaded in the VTR, checking of the reel number 1062 and seeking to the specified time code 1063 are finished successfully, and the material restored from the backup tape normally. However, when attempted to restore from the original tape, if the original tape is loaded into the VTR, the reel number and time code of the original tape are different from the new reel number 1062 and time code 1063 assigned at the time of backup. Therefore, either checking of the reel number 1062 or seeking to the specified time code 1063, or both are finished unsuccessfully. That is, if the material is once backed up, it cannot be restored from the original tape. If the backup tape is lost or broken, the material cannot be restored.

### SUMMARY OF THE INVENTION

An editing apparatus comprises:

a material storage for storing a material;

a material capture unit for taking in a material from first external media to the material storage;

a material output unit for sending the material stored in the material storage to second external media; and

a material information management unit for managing external media information including the information of at least one of

material area information showing storing position of the material in the material storage,

information specifying the first external media,

information specifying the storing place of the material in the first external media,

information specifying the second external media, and

information specifying the storing place of the material in the second external media,

wherein the material information management unit has an external media information store region for storing the external media information.

### BRIEF DESCRIPTION OF THE DRAWINGS

FIG. 1 is a diagram showing an editing apparatus in an exemplary embodiment of the invention.

FIG. 2 is a diagram showing an example of material area information, original external media information, and backup external media information in the exemplary embodiment of the invention.

FIG. 3 is a diagram showing an example of material area information, original external media information, and backup external media information in the exemplary embodiment of the invention.

FIG. 4 is a diagram showing an example of material area information and external media information in the exemplary embodiment of the invention.

FIG. 5 is a diagram showing an example of material area information, original external media information, and backup external media information in the exemplary embodiment of the invention.

FIG. 6 is a diagram showing a state before backup in a conventional editing apparatus.

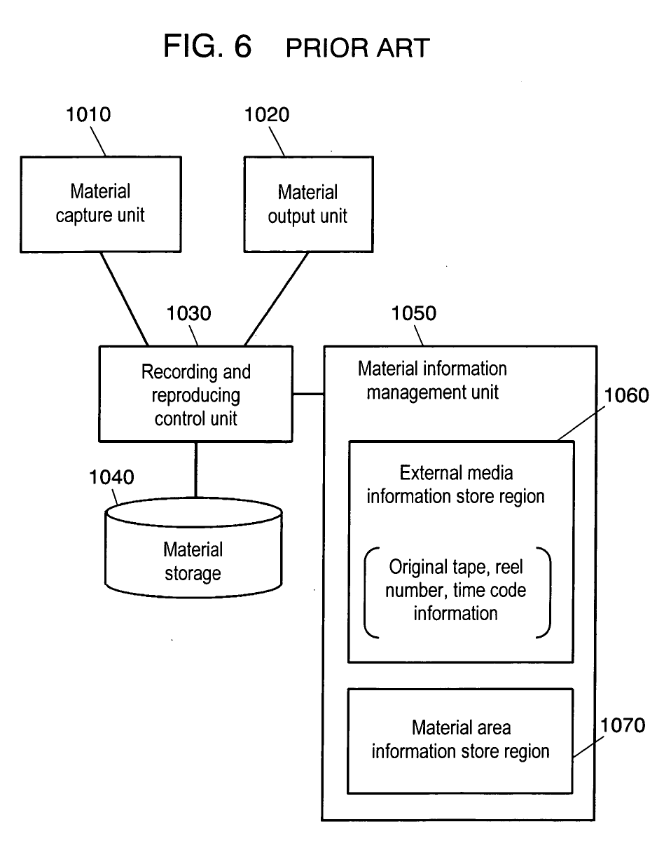

FIG. 7 is a diagram showing a state after backup in the conventional editing apparatus.

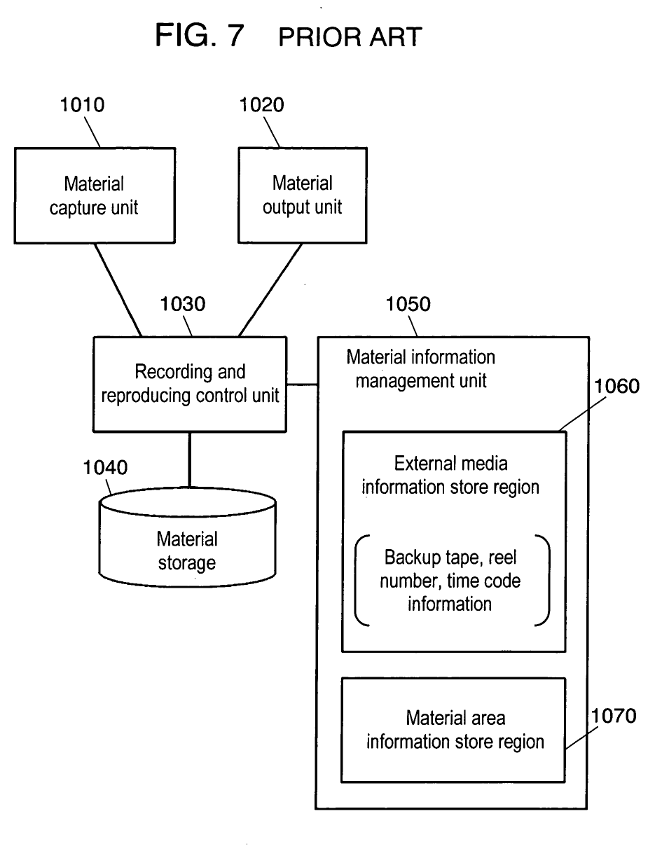

FIG. 8 is a diagram showing an example of material area information and external media information in the conventional editing apparatus.

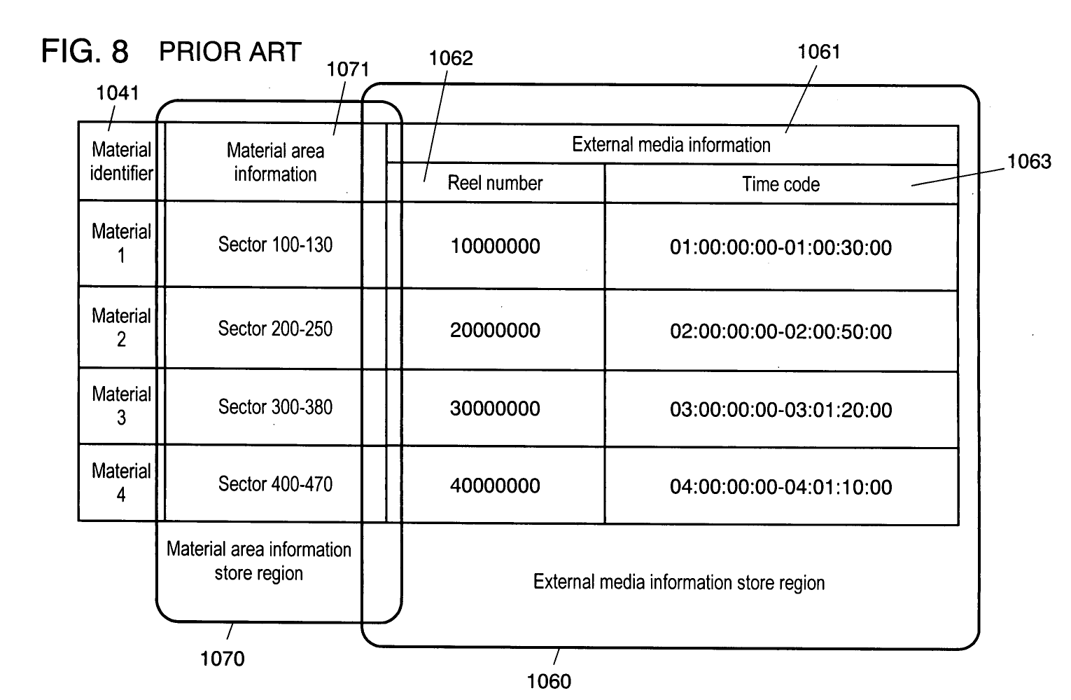

### DETAILED DESCRIPTION OF THE EXEMPLARY EMBODIMENTS

The present invention is devised in the light of the above problems, and it is hence an object thereof to enable to restore a material from original media and/or backup media with coexistence of information of backup media and information of original media.

The editing apparatus of the invention includes an external media information store region, and manages both information of backup media and information of original media, so that the material can be restored from either backup media or original media.

An exemplary embodiment of the invention is described below while referring to the drawings.

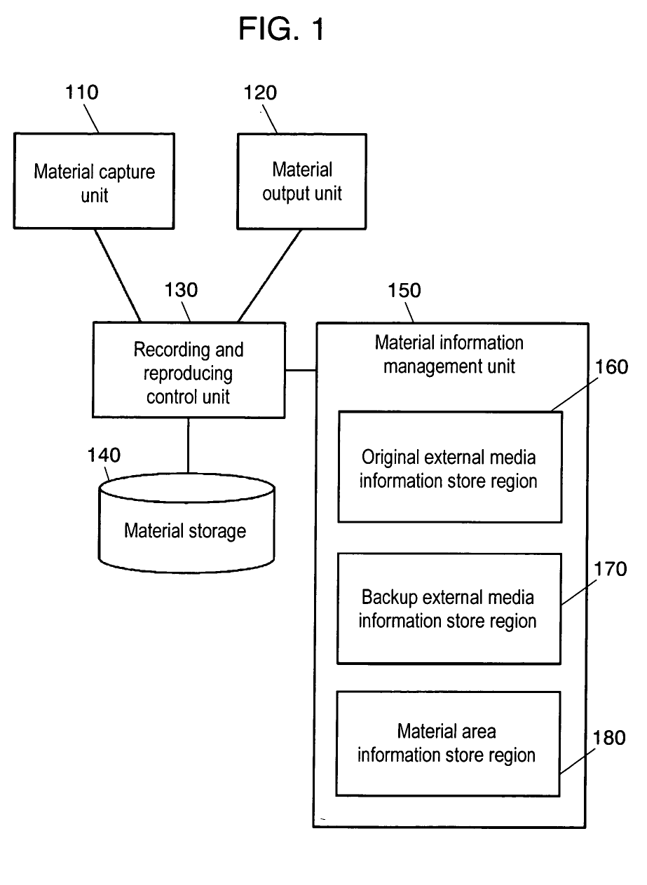

FIG. 1 shows an editing apparatus of the invention. In FIG. 1, the editing apparatus comprises a recording and reproducing control unit 130, a material information management unit 150, a material storage 140, a material capture unit 110, and a material output unit 120. The material information management unit 150 further includes an original external media information store region 160, a backup external media information store region 170, and a material area information store region 180. The original external media information store region 160 is a region for storing the media information of original external media or the first external media, and the backup external media information store region 170 is a region for storing the media information of backup external media or the second external media. The first external media include magnetic tape, optical disk, semiconductor memory, and network appliance. An example of using a magnetic tape as first external media is explained below. The second external media includes magnetic tape, optical disk, semiconductor memory and network appliance. An example of using a magnetic tape as second external media is explained below. Examples of using optical disk, semiconductor memory and network appliance as first external media and second external media are explained later.

In the first place, a material capture procedure is described. When the user requests capture of a desired material (not shown in FIG. 1), the material capture unit 110 captures the material on the magnetic tape such as video reproduced by a VTR or the like, and sends to the recording and reproducing control unit 130. The recording and reproducing control unit 130 stores the material in the material storage 140, and sends the recorded sector information to the material information management unit 150. The material information management unit 150 stores this information in the material area information store region 180. Simultaneously with capture of the material, the material capture unit 110 acquires the reel number information and material time code information from the magnetic tape (hereinafter called original tape), and sends these pieces of information to the material information management unit 150. The material information management unit 150 judges that the present process is material captured from the user's request, and stores the transmitted reel number information and material time code information in the external media information store region 160.

Next, a material backup procedure is described. When the user requests backup of a desired material (not shown in FIG. 1), the material information management unit 150 reads out sector information from the material area information store region 180, and sends it to the recording and reproducing control unit 130. The recording and reproducing control unit 130 reads out the material indicated by the sector information from the material storage 140, and records into the magnetic tape (hereinafter called backup tape) loaded in the VTR from the material output unit 120 (such recording is called backup hereinafter). The magnetic tape loaded in the VTR is the second external media. At this time, a new reel number and time code are written into the backup magnetic tape. The new reel number and time code are determined, for example, by specifying by the user (not shown in FIG. 1). Or they may be automatically assigned by the system. When assigning the reel number automatically, it may be determined, for example, by storing the greatest reel number ever given in the editing apparatus, and newly giving one greater reel number. Or the backup execution date and the serial number of the tape backed up on the same date may be linked together. For example, in the case of the fifth backup tape on Mar. 4, 2002, the last two digits of the year, and two digits each of month, day, and serial number are linked together, and the new reel number is assigned as “02030405.” The material information management unit 150 stores the new reel number information and time code information in the backup external media information store region 170.

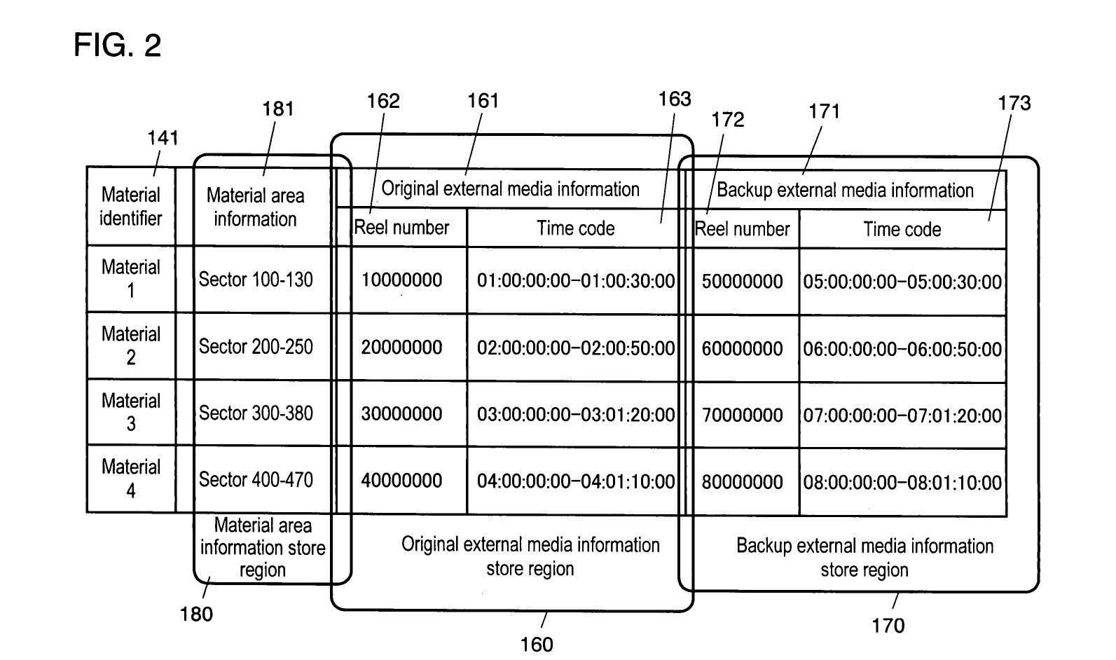

FIG. 2 shows an example of material area information, original external media information, and backup external media information at this time. In FIG. 2, a material identifier 141 identifies the individual materials stored in the material storage 140. Original external media information 161 is the information stored in the original external media information store region 160, in which reel number 162 and time code 163 are present. Backup external media information 171 is the information stored in the backup external media information store region 170, in which reel number 172 and time code 173 are present.

In this example, when the material identifier 141 is “Material 1”, a material in the original tape of which reel number 162 is “10000000” is captured for 30 seconds from time code 163 of “01:00:00:00” to “01:00:30:00”, and it is stored in sectors 100 to 130 in the material storage 140 composed of hard disk or the like. In the backup tape of which reel number 172 is “50000000”, the data is backed up in the time code 173 from “05:00:00:00” to “05:00:30:00”. In every material identifier 141 thus captured in, the material area information 181, original external media information 161, and backup external media information 171 are stored. The material area information 181 is the information showing the storing position of the material in the material storage 140.

The material in the material storage 140 may be temporarily deleted from the material storage 140 for the purpose of increasing the vacant capacity of the material storage 140 or other reason. When this material is needed later, the material is captured in again from the magnetic tape and restored.

This restoring procedure is explained. First, suppose to restore from the backup tape. When the user requests to restore from the backup tape (not shown in FIG. 1), the editing apparatus instructs the user to load the backup tape into the VTR (not shown in FIG. 1), and the material information management unit 150 reads out the information of reel number 172 and the information of time code 173 from the backup external media information store region 170, and sends them to the recording and reproducing control unit 130. The recording and reproducing control unit 130 sends the information to the material capture unit 110. The material capture unit 110 compares this reel number 172 with the reel number of the magnetic tape loaded in the VTR, and when matched, the tape is sought to the position of the time code 173. When the backup tape is loaded in the VTR by the user, checking of the reel number 172 and seeking to the specified time code 173 are successful. Thus, the material is restored and stored in the material storage 140.

Next, suppose to restore from the original tape. The procedure is basically same as in the case of restoring from the backup tape. When the user requests to restore from the original tape (not shown in FIG. 1), the editing apparatus instructs the user to load the original tape into the VTR (not shown in FIG. 1), and the material information management unit 150 reads out the information of reel number 162 and the information of time code 161 from the original external media information store region 160, and sends them to the recording and reproducing control unit 130. The recording and reproducing control unit 130 sends the information to the material capture unit 110. The material capture unit 110 compares this reel number 162 with the reel number of the tape loaded in the VTR, and when matched, the tape is sought to the position of the time code 163. When the original tape is loaded in the VTR by the user, checking of the reel number 162 and seeking to the specified time code 163 are successful. Thus, the material is restored and stored in the material storage 140.

In the exemplary embodiment of the invention, in this manner, the material information management unit 150 has external media information store regions corresponding to the original tape and backup tape. Therefore, the material can be restored either from the original tape or from the backup tape, and if one tape is lost or broken, the material can be restored from the other one.

Also in the exemplary embodiment of the invention, the material information management unit 150 has one external media information store region each for the original tape and backup tape, but a plurality of backup tape external media information store regions may be provided. In such a case, if a plurality of backup tapes are prepared, the information in all of them can be saved.

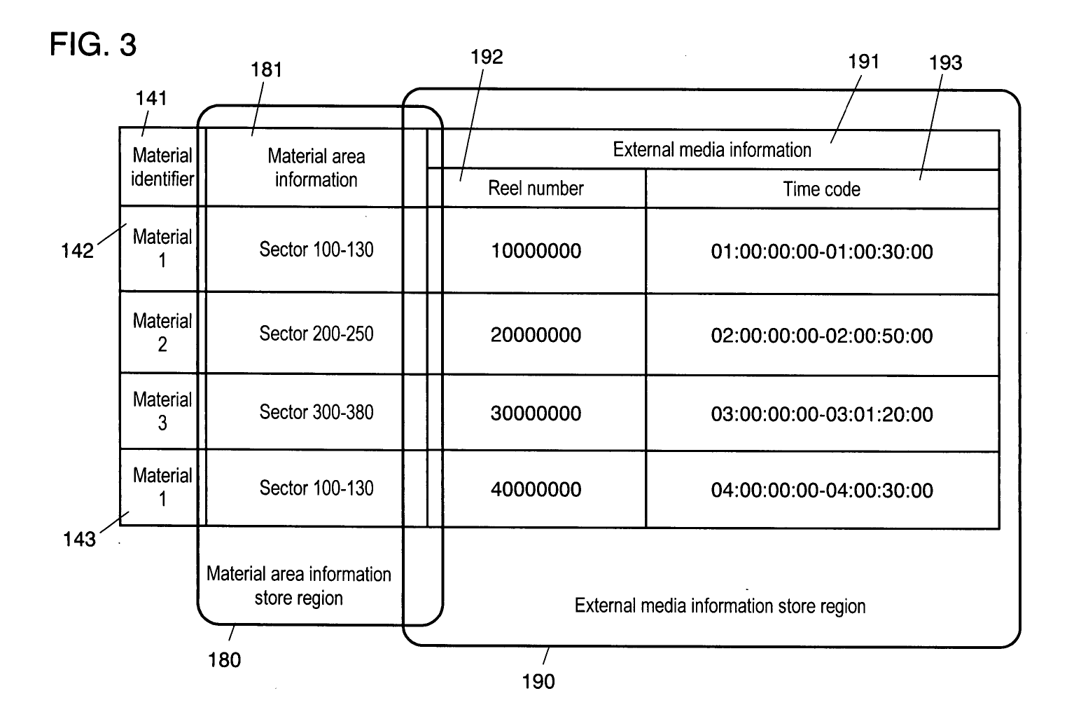

In the exemplary embodiment, the material information management unit 150 has external media information store regions corresponding to the original tape and backup tape. But, in a common external media information store region, the information of reel numbers corresponding to the original tape and backup tape and information of external media can be stored. In this case, when backing up the material, the external media information of the original tape is held unchanged without overwriting, and external media information is newly stored by relating to the same area information newly in a same material. FIG. 3 shows such method.

In FIG. 3, same parts as in FIG. 2 are identified with same reference numerals and their specific description is omitted. External media information 191 is the information stored in an external media information store region 190, in which reel number 192 and time code 193 are present. To back up “Material 1” stored in the material storage 140 from sectors 100 to 130, the information of reel number 192 of “10000000” and time code 193 of “01:00:00:00-01:00:30:00” of the original tape as the source of capture is held in line 142, and reel number 192 “40000000” and time code 193 “04:00:00:00-04:00:30:00” of the backup tape are newly stored as other information. The other information thus stored newly is line 143 of “Material 1” written in the fourth column of the material identifier 141. As a result, the external media information about “Material 1” is stored in a plurality, and the material can be restored from either original tape or backup tape. Therefore, it is an advantage that, if one tape is lost or broken, the material can be restored from the other one, and when the backup tape is prepared in a plurality, all information can be held.

In the above explanation, the magnetic tape is used as the capture source media and backup destination media. In the editing apparatus of the invention, the capture source media and backup destination media are not specified, and the disk media, semiconductor memory, or network appliance can be used. Also in the above explanation, the material storage 140 is the hard disk, but, not limited to this, the material storage 140 of the editing apparatus of the invention may be also magnetic tape, optical disk, semiconductor memory, or network appliance. The network appliance herein is, for example, an appliance connected by the USB, IEEE1394, TCP/IP or other standard.

An example of using different media for first external media and second external media is explained below by referring to the drawing.

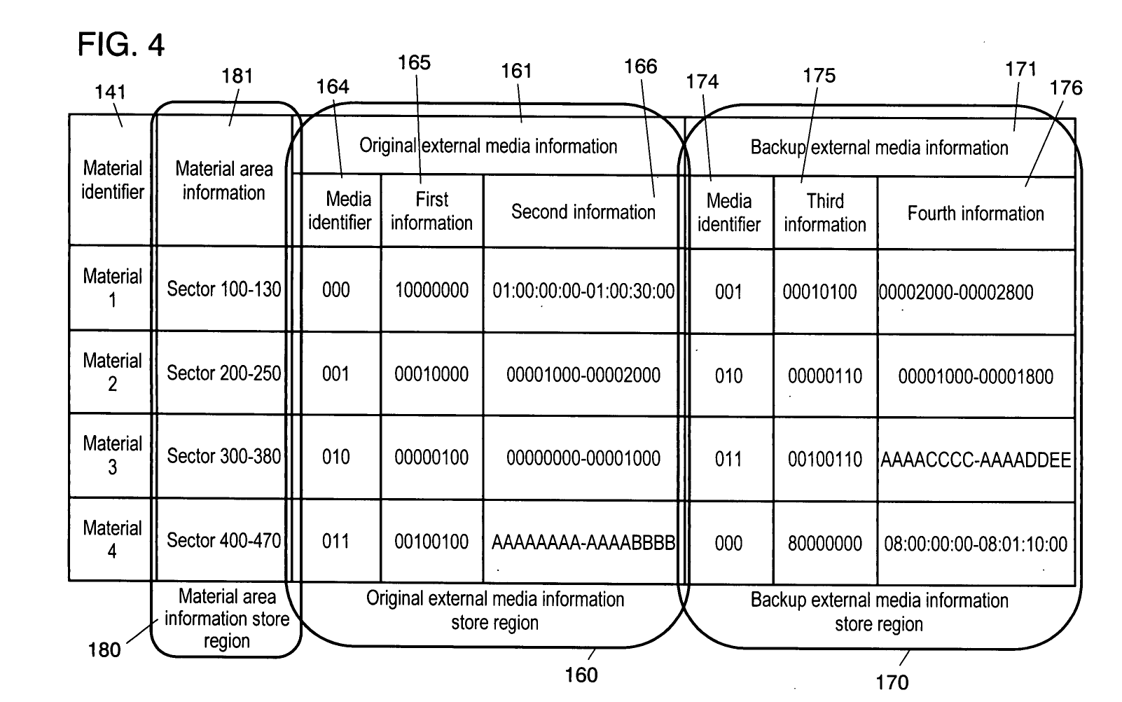

In FIG. 4, same parts as in FIG. 2 are identified with same reference numerals and their specific description is omitted. Original external media information 161 is the information stored in an original external media information store region 160. The original external media information 161 includes media identifier 164 as media identification information, and first information 165 and second information 166. Backup external media information 171 is the information stored in a backup external media information store region 170. The backup external media information 171 includes media identifier 174 as media identification information, and third information 175 and fourth information 176. The first information 165 and third information 175 are the information of the reel number when the external media is a magnetic tape, the information of volume label when the external media is an optical disk, the information of the given memory bank when the external media is a semiconductor memory, or the ID information of given IP address or the like when the external media is a network appliance. They are examples of the first information 165 and third information 175. The second information 166 and fourth information 176 are the information of the time code when the external media is a magnetic tape, the information of sector position or information of file path when the external media is an optical disk, the information of address in the memory or information of file path when the external media is a semiconductor memory, or the information of given logic address or information of file path when the external media is a network appliance. They are examples of the second information 166 and fourth information 176. As the media identifier 164 and media identifier 174, “000” is stored when the external media is a magnetic tape, “001” is stored when the external media is an optical disk, “010” is stored when the external media is a semiconductor memory, or “011” is stored when the external media is a network appliance. Concerning “Material 1” of the material identifier 141, the material area information 181 is sectors 100-130, the media identifier 164 is “000” indicating a magnetic tape, the first information 165 is “10000000” showing the information of reel number, the second information 166 is “01:00:00:00-01:00:30:00” showing the information of time code, the media identifier 174 is “001” indicating an optical disk, the third information 175 is “00010100” showing the information of volume label, and the fourth information 176 is “00002000-00002800” showing the information of sector position. Concerning “Material 3” of the material identifier 141, the material area information 181 is sectors 300-380, the media identifier 164 is “010” indicating a semiconductor memory, the first information 165 is “00000100” showing the information of memory bank, the second information 166 is “00000000-00001000” showing the information of memory address, the media identifier 174 is “011” indicating a network appliance, the third information 175 is “00100110” showing the ID information, and the fourth information 176 is “AAAACCCC-AAAADDEE” showing the information of logic address.

In this manner, by storing also the media identifier 164 and media identifier 174 for identifying the type of media, the editing apparatus can smoothly use different media as external media.

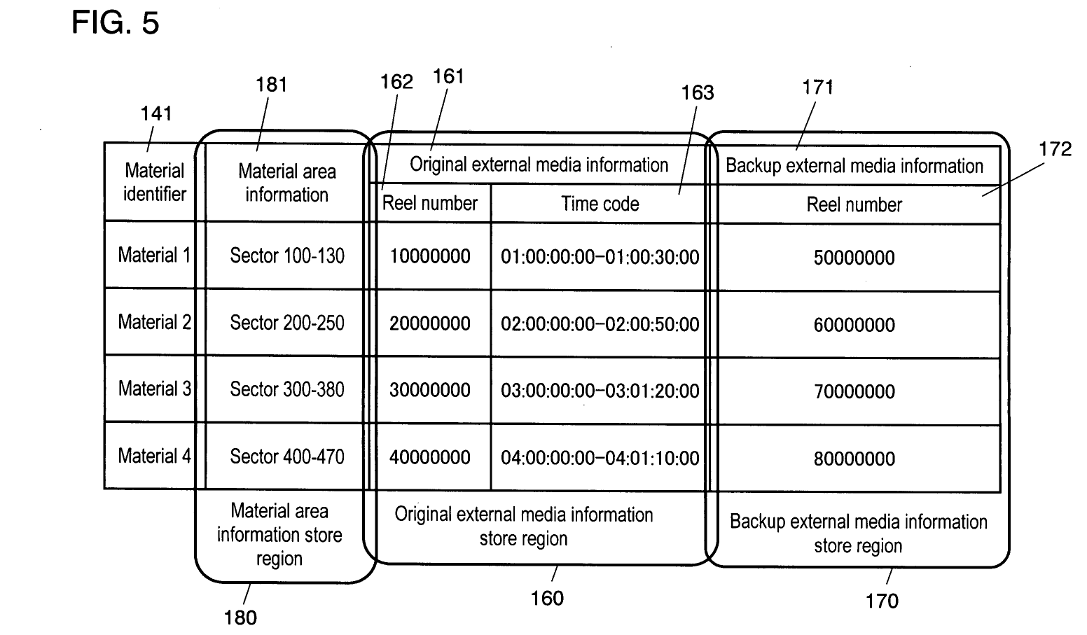

In the backup operation in the editing apparatus, the material is often backed up in a predetermined specific place in the backup media. For example, in the case of a magnetic tape used as backup media, backup may be executed from the beginning of the magnetic tape, or may be recorded from a specified value of a predetermined time code. That is, in such a case, it is not necessary to store the information of time code as the backup media information. FIG. 5 is a diagram showing an example of material area information, original external media information, and backup external media information in such a case.

In FIG. 5, same parts as in FIG. 2 are identified with same reference numerals and their specific description is omitted. Backup external media information 171 is the information stored in a backup external media information store region 170, in which only reel number 172 is stored. Information of time code 173 as shown in FIG. 2 is not stored.

In the foregoing explanation, the original external media information 161, backup external media information 171, and external media information 191 are examples of external media information in the invention.

The reel number 162, reel number 172, reel number 192, media identifier 164, media identifier 174, first information 165, and third information 175 are examples of the information for specifying the external media in the invention. The time code 163, time code 173, time code 193, second information 166, and fourth information 176 are examples of the information for specifying the storing place of the material in the external media in the invention.

Thus, according to the invention, the material can be restored from either the original media or the backup media, and if either media is lost or broken, the material can be restored from the other media. The invention also brings out a merit of allowing to edit by using various media.

What is claimed is:

1. An editing apparatus comprising:
a material storage for storing a material;
a material capture unit for taking in a material from first external media to said material storage;
a material output unit for sending the material stored in said material storage to second external media; and
a material information management unit for managing external media information including the information of at least one of
material area information showing storing position of the material in said material storage,
information specifying the first external media,
information specifying the storing place of the
material in the first external media,
information specifying the second external media, and
information specifying the storing place of the material in the second external media,
wherein said material information management unit has an external media information store region for storing the external media information.

2. The editing apparatus of claim 1, wherein the external media information store region includes an original external media information store region for storing the information of the original media from which the material is taken.

3. The editing apparatus of claim 2,
wherein said material information management unit stores the external media information of the first external media in the original external media information store region when said material capture unit captures the material from the first external media; and
wherein said material information management unit stores the second external information different from the first external media into the external media information store region different from the original external media information store region when said material output unit sends out the material stored in the material storage into the second external media.

4. The editing apparatus of any one of claims 1 to 3,
wherein the first external media is at least one of magnetic tape, optical disk, semiconductor memory and network appliance; and
wherein the second external media is at least one of magnetic tape, optical disk, semiconductor memory and network appliance.

5. The editing apparatus of claim 4,
wherein the material includes at least one of video and audio; and
wherein the external media information includes at least one of reel number and time code of the magnetic tape when the first external media is magnetic tape or the second external media is magnetic tape.

6. The editing apparatus of claim 4,
wherein the material includes at least one of video and audio; and
wherein the external media information includes at least one of volume label, sector position and file path of the optical disk when the first external media is optical disk or the second external media is optical disk.

7. The editing apparatus of claim 4,
wherein the material includes at least one of video and audio; and
wherein the external media information includes at least one of information of memory bank, memory address and file path of the semiconductor memory when the first external media is semiconductor memory or the second external media is semiconductor memory.

8. The editing apparatus of claim 4,
wherein the material includes at least one of video and audio; and
wherein the external media information includes at least one of ID information, logic address and file path of the network appliance when the first external media is network appliance or the second external media is network appliance.

9. The editing apparatus of claim 1, wherein the external media information further includes at least one of media identification information for identifying the first external media and media identification information for identifying the second external media.
